(19) United States
(12) Patent Application Publication
(10) Pub. No.: US 2005/0059268 A1
(43) Pub. Date: Mar. 17, 2005

(54) Electrical connector having improved contact

(76) Inventor: Wei Yu, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/944,210

(22) Filed: Sep. 16, 2004

(30) Foreign Application Priority Data
Sep. 17, 2003 (TW) 92216667

(51) Int. Cl. H01R 12/00

(52) U.S. Cl. 439/65

(57) ABSTRACT

An electrical connector assembly (1) includes a plug connector (4) and a receptacle connector (5). The plug connector includes a plug housing (40) defining an array of passageways (403) for receiving an array of male contacts (20). The receptacle connector includes a receptacle housing (50) defining an array of recesses (504) for receiving an array of female contacts (30). Each male contact defines a dual laterally offset cantilevered spring arms (24, 26) to define an inserted mouth (28). Each spring arm forms an inwardly bent contact portion (24a, 26a). The female contact includes a main portion (31) defining a pair of laterally offset depressions (310) positioned in opposite sides of the main portion for retaining the contact portions of the male contact.

### BACKGROUND OF THE INVENTION

1. Field of the Invention

The present invention generally relates to an electrical connector, and more particularly to a high density I/O connector, such as an array connector.

2. Description of the Prior Art

In electrical connector field, various female contacts are provided for electrically connecting with male contacts. In order to establish a satisfactory electrical connection between the female contact and the male contact, more effort to provide an electrical contact structure is characterized in modifying the female contacts. U.S. Pat. No. 5,290,181 discloses a male contact 20 and a female contact 30. The male contact 20 includes a base portion 22 and a pair of laterally offset cantilevered spring beams 24, 26 forwardly extending from opposite sides of the base portion 22, thereby defining an inserted mouth 28 adapted for mating with the female contact 30. The female contact 30 defines a final contact area 36 and a lead-in portion forming inwardly opposing, laterally offset, symmetrical cam portions 38b, 40b. As the male contact 20 mates with the female contact 30, the cantilevered spring arms 24, 26 of the male contact slide along the cam portions 38b, 40b of the female contact 20 and are outwardly deflected to engage with the final contact area 36. However, during insertion or removal, the male contact 20 must be inserted into the female contact 30 with sufficient normal force, therefore the cantilevered spring beams 24, 26 of the male contact 20 may be easily excessively deflected to intervene a housing which receives the spring beams 24, 26 of the male contact 20 and even be broken away due to an inaccurate external force. Furthermore, the inserted mouth 28 defined by the cantilevered spring arms 24, 26 must be wide enough to make the female contact 30 conveniently be inserted therein, whereby a pitch between the adjacent male contacts 20 is inevitably increased.

Hence, an improved electrical contact structure is directed to overcome the above problem.

### SUMMARY OF THE INVENTION

It is an object of the present invention to provide an electrical connector assembly having a contact which can effectively reduce the distortion of a complementary contact.

In order to attain the object above, an electrical connector assembly according to the present invention includes a plug connector and a receptacle connector. The plug connector includes a plug housing defining an array of passageways for receiving an array of male contacts. The receptacle connector includes a receptacle housing defining an array of recesses for receiving an array of female contacts. Each male contact defines a dual laterally offset cantilevered spring arms to define an inserted mouth. Each spring arm forms an inwardly bent contact portion. The female contact includes a main portion defining a pair of laterally offset depressions for securely retaining the contact portions of the male contact. While the male contact mates with the female contact, the cantilevered spring arms are deflected outwardly and the main portion of the female contact is retained in the inserted mouth of the male contact.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an exploded view of an electrical connector assembly according to a first embodiment of the present invention;

FIG. 2 is a perspective view of a male contact of the electrical connector assembly;

FIG. 3 is a perspective view of a female contact of the electrical connector assembly according to the first embodiment;

FIG. 4 is an assembled view of the electrical connector assembly, with parts cut away to show the male contact and the female contact mated together;

FIG. 5 is a an enlarged view of a circular area of FIG. 4;

FIG. 6 is a perspective view of the female contact according to a second embodiment; and

FIG. 7 is a perspective view of the female contact according to a third embodiment.

### DETAILED DESCRIPTION OF THE PREFERRED EMBODIEMNT

Reference will now be made in detail to the preferred embodiment of the present invention.

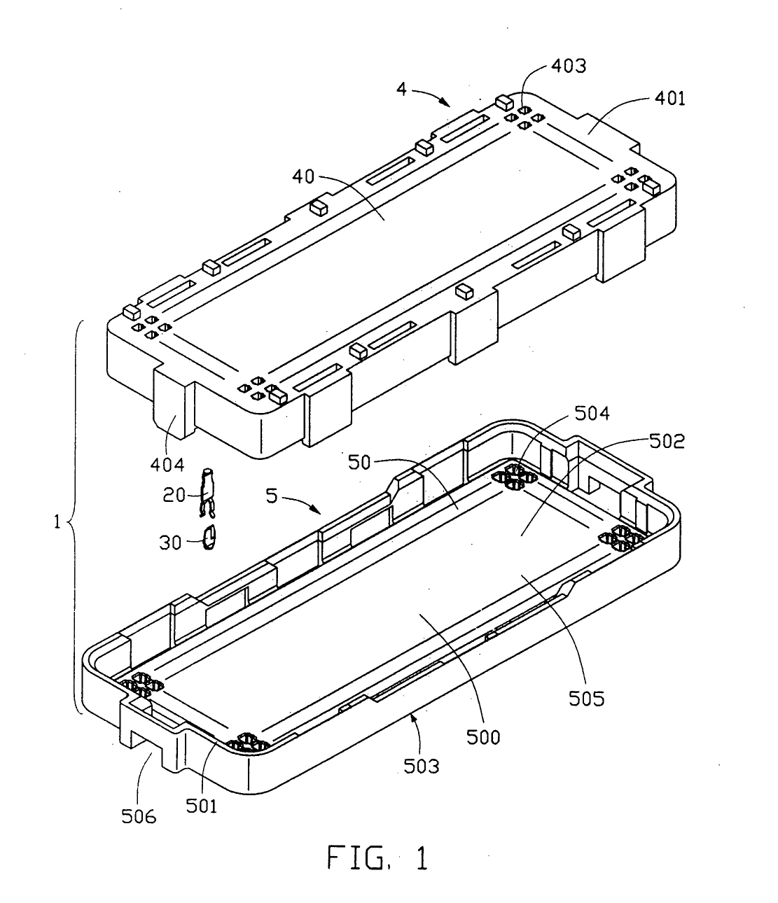

Referring to FIG. 1, an electrical connector assembly 1 according to the present invention includes a plug connector 4 and a receptacle connector 5. The plug connector 4 includes an elongated plug housing 40 and a plurality of male contacts 20 retained in the plug housing 40. The receptacle connector 5 includes an elongated receptacle housing 50 and a plurality of female contacts 30 retained in the receptacle housing 50. The plug housing 40 defines a mounting face 401 facing a printed circuit board (not shown) to which the plug connector 4 is mounted and a first mating face 402 for mating with the receptacle connector 5. An array of slots 403 for receiving the male contacts 20 are defined through the mounting face 401 and the mating face 402. A pair of projections 404 outwardly project from opposite edges of the plug housing 40. The receptacle housing 50 defines a base portion 500 and a peripheral wall 501 extending upwardly from the base portion 500, thereby forming a receiving room 505 for preferably receiving the plug housing 40. The base portion 500 defines a second mating face 502 for facing the first mating face 402 of the plug housing 40 and a second mounting face 503 opposite to the second mating face 502 for facing another printed circuit board (not shown) to which the receptacle connector 5 is mounted. The base portion 500 further defines an array of channels 504 corresponding to the slots 403 of the plug housing 40 for receiving the female contacts 30. A pair of recesses 506 are defined in opposite sides of the receptacle housing 50 for receiving the corresponding projections 404 of the plug housing 40.

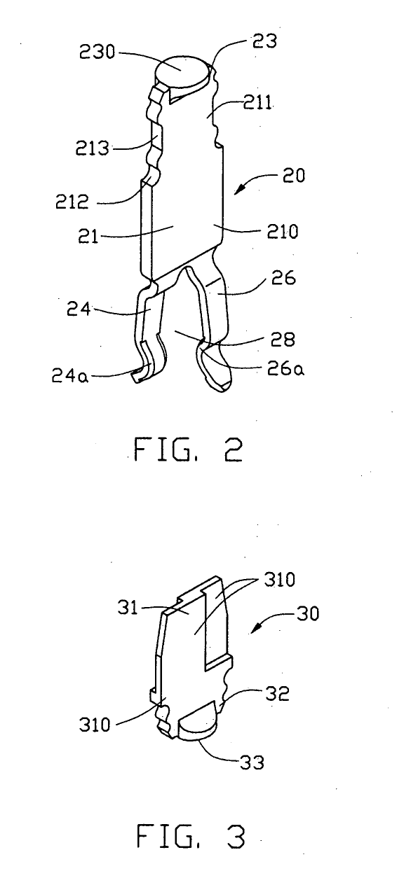

As shown in FIG. 2, the male contact 20 is formed by stamping a sheet metal of a desired thickness and includes an elongate body portion 21 of a rectangular shape, a pair of laterally offset cantilevered spring arms 24, 26 downwardly extending from opposite edges of the body portion 21 and a tail portion 23 extending from a tip end of the body portion 21. The body portion 21 includes a lower portion 210 and an upper portion 211. The width of the lower portion 210 is bigger than the width of the upper portion 211, thereby forming a shoulder 212 positioned in either side edge of the body portion 21 and a recessed portion 213 above the shoulder 212 for securely engaging with a step portion (not shown) of the slot 403 of the plug housing 40. The cantilevered spring arms 24, 26 respectively define an inwardly bent contact portion 24a, 26a. The contact portions 24a, 26a are spaced from each other, thereby forming an inserted mouth 28 therebetween. A circular-shaped solder pad 230 is formed at a tip of the tail portion 23 for positioning a solder ball (not shown) which is applicable for soldering the male contact 20 to the printed circuit board.

As shown in FIG. 3, the female contact 30 according to the first embodiment is formed by stamping from a sheet metal of a desired thickness and is substantially a rectangular shape. The female contact 30 includes a main portion 31 and a tail portion 32 downwardly extending from the main portion 31. The main portion 31 includes a pair of shoulders 310 positioned in opposite edges thereof for securely engaging with corresponding step portions (not shown) of the recess 504 of the receptacle housing 50. A pair of laterally offset depressions 310 are respectively formed in opposite sides of the main portion 31 and extending through opposite edges of the main portion 31. A circular-shaped solder pad 33 is formed at an end portion of the tail portion 32 for positioning a solder ball (not shown) which is applicable for soldering the receptacle connector 5 to the corresponding printed circuit board.

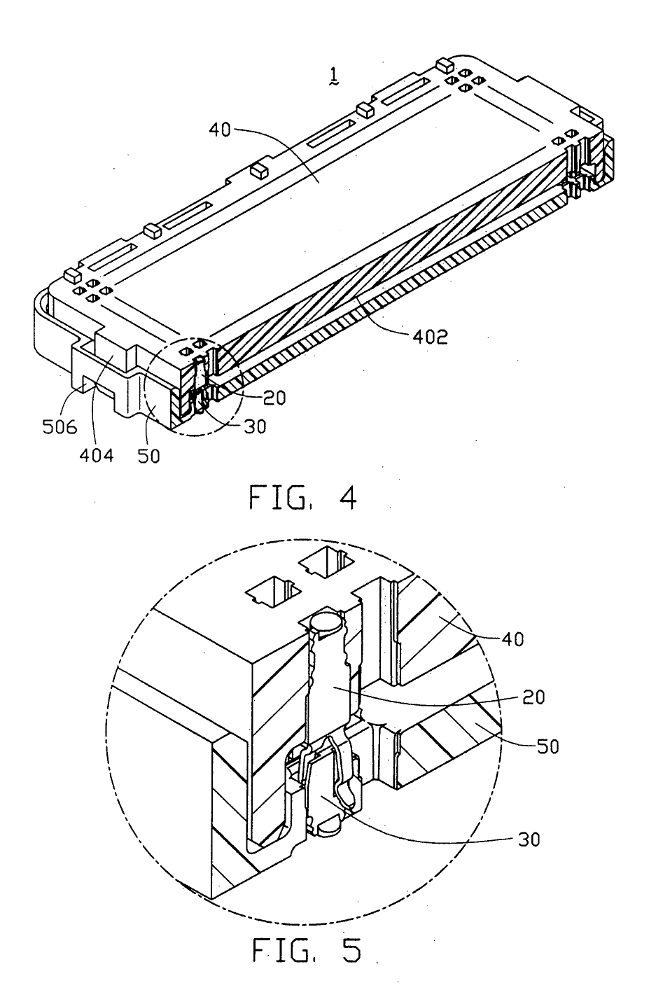

Referring to FIGS. 4-5 in conjunction with FIG. 1, in assembly, the plug housing 40 is assembled to the receptacle housing 50 with the first mating face 402 of the plug housing 40 engaging with the second mating face 502 of the receptacle housing 50. The projections 404 of the plug housing 40 are received in the corresponding recesses 506 of the receptacle housing 50 for polarizing purpose. In moving from an initial position (the male contact 20 disconnecting with the female contact 30) to a final position (the male contact 20 engaging with the female contact 30), the dual cantilevered spring arms 24, 26 of the male contact 20 are outwardly deflected and respectively slide along the corresponding depressions 310 of the female contact 30, finally the inwardly bent contact portions 24a, 26a securely engage with the depressions 310 and the main portion 31 of the female contact 30 is inserted into the inserted mouth 28 of the male contact 20, as best seen in FIG. 5. Due to the female contact 30 with a desired thickness, the female contact 30 is not easily deformed or distorted during mating course. Furthermore, due to the female contact 30 with depressions 310 defined therein, a distance between the initial position to the final position of the cantilevered spring arms 24, 26 of the male contact 20 is smaller than a thickness of the main portion 31 of the female contact 20 during the mating course compared to the prior arts, thereby effectively preventing the male contact 20 from intervening the plug housing 40.

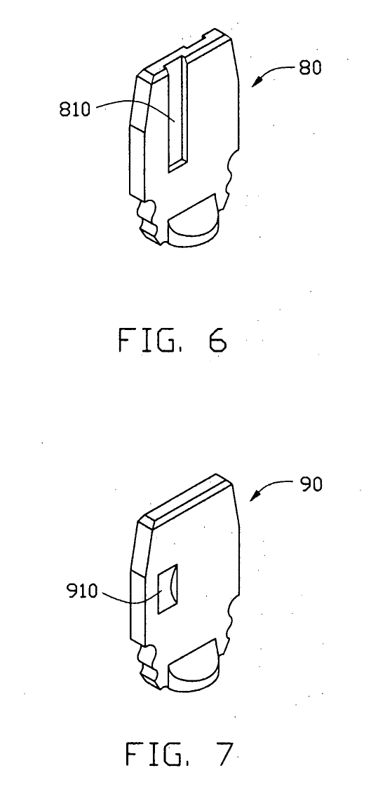

FIG. 6 shows a perspective view of a female contact 80 according to a second embodiment. The female contact 80 is substantially identical to the female contact 30 in structure as described above in relation to FIG. 3. Therefore, further details of the female contact 80 will not be repeated, except for a pair of laterally offset depressions 810. The depressions 810 are not extended through lateral edges of the female contact 80, thereby further preventing the inserted male contact 20 from being laterally divorced from the female contact 80.

FIG. 7 is a perspective view of a female contact 90 according to a third embodiment. The female contact 90 is still substantially identical to the female contact 30 in structure as described above, except for a pair of laterally offset notches 910 for securely engaging with the contact portions 24a, 26a of the male contact 20.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

1. An electrical connector assembly adapted for mounting on a printed circuit board, comprising:
a plug connector having a plug housing defining an array of slots therewithin;
a receptacle connector having a receptacle housing defining an array of channels therewithin;
a plurality of male contacts disposed in the corresponding slots of the plug housing, each male contact having dual spring arms to define an inserted mouth therebetween, each spring arm forming a contact portion; and
a plurality of female contacts disposed in the corresponding channels of the receptacle housing, each female contact having a main portion received in the inserted mouth of the male contact, the main portion defining a pair of laterally offset retaining portions therein for engaging with the contact portions of the spring arms of the male contact.

2. The electrical connector assembly according to claim 1, wherein the retaining portion is a depression.

3. The electrical connector assembly according to claim 1, wherein the retaining portion is a notch.

4. The electrical connector assembly according to claim 1, wherein the retaining portions are defined in opposite sides of the main portion of the female contact.

5. The electrical connector assembly according to claim 1, wherein the receptacle housing of the receptacle connector defines a receiving room for receiving the plug connector.

6. The electrical connector assembly according to claim 1, wherein the plug housing of the plug connector forms a pair of projections at opposite edges thereof.

7. The electrical connector assembly according to claim 6, wherein the receptacle housing of the receptacle connector defines a pair of recesses for receiving the corresponding projections of the plug housing.

8. A mating contact assembly, comprising:
a male contact with a desired thickness having a pair of laterally offset spring arms to define a mouth therebetween, each spring arm forming a contact portion; and
a female contact with a desired thickness having a main portion defining a pair of laterally offset retaining portions for engaging with the contact portions of the male contact, the female contact being inserted into the mouth of the male contact with the spring arms being deflected outwardly, a deformation of the spring arms of the male contact being smaller than the thickness of the female contact in mating course.

9. The contact assembly according to claim 8, wherein the retaining portions are respectively defined in opposite sides of the main portion of the female contact.

10. The contact assembly according to claim 8, wherein the retaining portions of the female contact are depressions.

11. The contact assembly according to claim 8, wherein the retaining portions of the female contact are notches.

12. A mating contact structure assembly comprising:
a first contact defining a first main body with a first mounting section and a first mating section at two ends in a first longitudinal direction thereof;
a second contact defining a second main body with a second mounting section at one end in a second longitudinal direction thereof;
the first mating section including a pair of split resilient arms extending by two sides of the first main body in a first lateral direction perpendicular to said first longitudinal direction;
the second main body being essentially of a planar form defining a pair of recessed areas in two opposite faces in a second lateral direction thereof perpendicular to said second longitudinal direction; wherein
said pair of recessed areas receive the corresponding resilient arms, respectively.

13. The contact structure assembly as claimed in claim 12, wherein each of said recessed areas extends through an upper edge of the second main body.

14. The contact structure assembly as claimed in claim 13, wherein each of said recessed areas further extends through a side edge of the second main body.
